(19) United States
(12) Patent Application Publication
(10) Pub. No.: US 2014/0027060 A1
(43) Pub. Date: Jan. 30, 2014

(54) GAS DISTRIBUTION APPARATUS FOR SUBSTRATE PROCESSING SYSTEMS

(71) Applicant: Applied Materials, Inc, Santa Clara, CA (US)

(72) Inventors: JOSEPH M. RANISH, San Jose, CA (US); MEHMET TUGRUL SAMIR, Mountain View, CA (US)

(73) Assignee: Applied Matericals, Inc, Santa Clara, CA (US)

(21) Appl. No.: 13/943,345

(22) Filed: Jul. 16, 2013

Related U.S. Application Data
(60) Provisional application No. 61/676,507, filed on Jul. 27, 2012.

(51) Int. Cl. B05B 13/00

(52) U.S. Cl. CPC B05B 13/00
USPC 156/345.33; 239/302

(57) ABSTRACT

In some embodiments, a gas distribution apparatus includes a first plate having a plurality of ports disposed through the first plate; a second plate disposed above and coupled to the first plate; a third plate disposed above and coupled to the second plate; a first plenum disposed between the first plate and the second plate and fluidly coupled to a first set of the plurality of ports, wherein the first plenum comprises a gas supply coupled to the first plenum to provide a process gas to an area proximate a substrate via a first set of the plurality of ports; a second plenum disposed between second plate and the third plate and fluidly coupled to the second set of ports, wherein the second plenum comprises a vacuum applied to the second plenum to remove reaction byproducts from the area proximate the substrate via a second set of the plurality ports.

### CROSS-REFERENCE TO RELATED APPLICATIONS

This application claims benefit of U.S. provisional patent application Ser. No. 61/676,507, filed Jul. 27, 2012, which is herein incorporated by reference.

### FIELD

Embodiments of the present invention generally relate to substrate processing systems, and more specifically to gas distribution apparatus for use in substrate processing systems.

### BACKGROUND

In substrate processing, reaction byproducts, for example formed from reactions of process gases provided to a substrate process chamber, are typically evacuated from the process chamber via an exhaust port. The exhaust port is typically disposed below a plane of the substrate being processed in the chamber on the floor or one or more sides of the process chamber. However, the inventor believes that by evacuating the reaction byproducts in such a manner, the reaction byproducts may be forced to flow across the top surface of the substrate. The inventor further believes that, as the reaction byproducts flow across the top surface of the substrate, the overall composition of process gases at various points across the substrate may be changed, thus changing the dynamics of subsequent reactions across the substrate, thereby causing process non-uniformities. The inventor also believes that this effect may be exacerbated at an edge of the substrate as the reaction by products accumulate as they flow across the substrate, thus providing a highest concentration of reaction byproducts proximate the edge of the substrate closest to the exhaust port.

Therefore, the inventor has provided an improved gas distribution apparatus for use in substrate processing apparatus.

### SUMMARY

Embodiments of gas distribution apparatus for use in substrate processing systems are provided herein. In some embodiments, a gas distribution apparatus may include a first plate having a plurality of ports disposed through the first plate; a second plate disposed above and coupled to the first plate; a third plate disposed above and coupled to the second plate; a first plenum disposed between the first plate and the second plate and fluidly coupled to a first set of the plurality of ports, wherein the first plenum comprises a gas supply coupled to the first plenum to provide a process gas to an area proximate a substrate disposed proximate the first plate via a first set of the plurality of ports; and a second plenum disposed between second plate and the third plate and fluidly coupled to the second set of ports, wherein the second plenum comprises a vacuum applied to the second plenum to remove reaction byproducts formed from a process gas reaction from the area proximate the substrate via a second set of the plurality ports.

In some embodiments, a process chamber may include a processing volume with a substrate support disposed therein; a gas distribution apparatus disposed above the substrate support to provide one or more gases to a substrate when disposed on the substrate support, the gas distribution apparatus comprising; a first plate having a plurality of ports disposed through the first plate; a second plate disposed above and coupled to the first plate; a third plate disposed above and coupled to the second plate; a first plenum disposed between the first plate and the second plate and fluidly coupled to a first set of the plurality of ports, wherein the first plenum comprises a gas supply coupled to the first plenum to provide a process gas to the processing volume via a first set of the plurality of ports; and a second plenum disposed between second plate and the third plate and fluidly coupled to the second set of ports, wherein the second plenum comprises a vacuum applied to the second plenum to remove reaction byproducts formed from a process gas reaction from the processing volume via a second set of the plurality ports.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a process chamber suitable for use with a gas distribution apparatus in accordance with some embodiments of the present invention.

FIG. 2 depicts a cross sectional view of a portion of a gas distribution apparatus in accordance with some embodiments of the present invention.

FIG. 3 depicts a bottom view of a gas distribution apparatus in accordance with some embodiments of the present invention.

FIG. 4 depicts a cross sectional view of a portion of a gas distribution apparatus in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of gas distribution apparatus for use in substrate processing systems are provided herein. In some embodiments, the inventive gas distribution apparatus may advantageously provide a vacuum applied to one or more ports of the gas distribution apparatus to facilitate a quick and efficient removal of process reaction byproducts from a surface of the substrate, thereby reducing or eliminating an effect the reaction byproducts may have on subsequent process reactions.

Embodiments of the inventive gas distribution apparatus disclosed herein may be used in any suitable process chamber, including but not limited to those adapted for processes such as Rapid Thermal Processing (RTP) or epitaxial deposition. An exemplary RTP chamber may include the RADIANCE® process chamber commercially available from Applied Materials, Inc of Santa Clara, Calif. It is contemplated that other process chambers may also benefit from the inventive gas distribution apparatus in accordance with the teachings herein, including chambers configured for other processes and chambers made by other manufacturers.

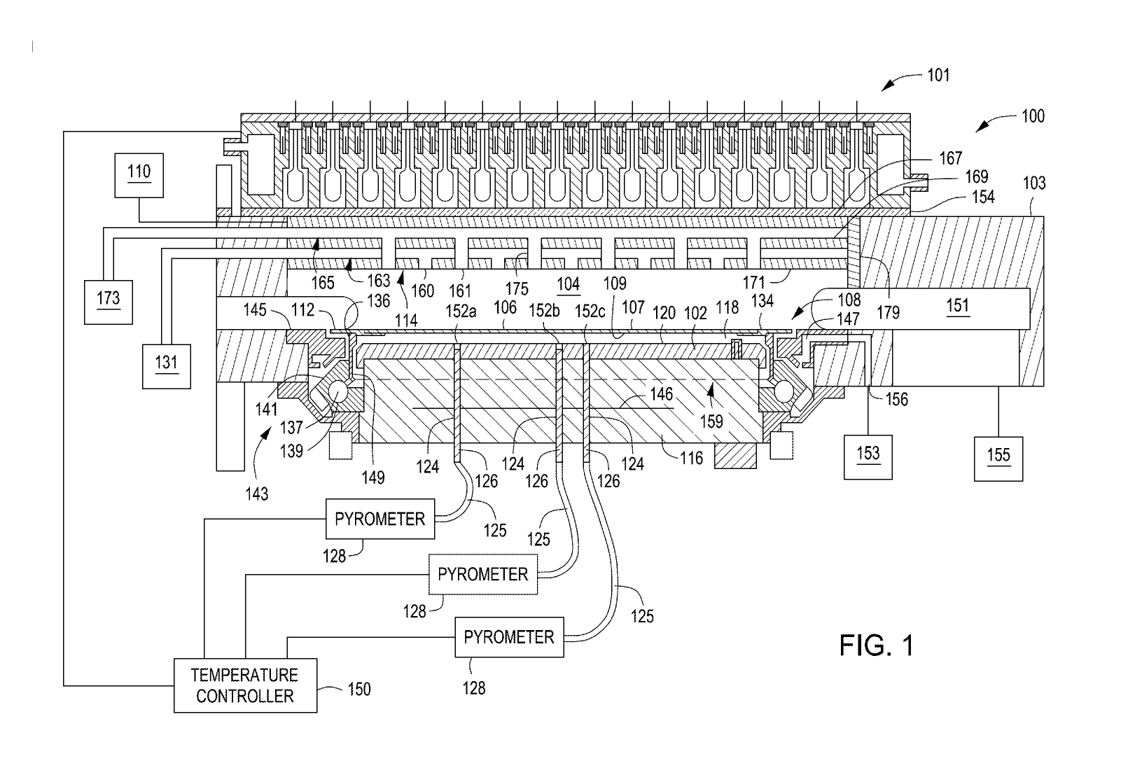

FIG. 1 depicts an exemplary process chamber 100 configured to perform RTP processes and suitable for use with the inventive gas distribution apparatus in accordance with some embodiments of the present invention. It is contemplated that the description below with respect to the gas distribution apparatus may be used in other process chambers having differing configurations. In some embodiments, the process chamber 100 may generally comprise a chamber body 103 having an inner volume 104, a substrate support 108 having a support surface to support a substrate 106 within the inner volume 104, a gas distribution apparatus 114 disposed opposing the substrate support 108 and one or more radiant heating sources (e.g., a lamp array 101) to provide heat to the substrate 106.

The substrate 106 may be any suitable substrate requiring processing, for example, by rapid thermal processing. The substrate 106 may comprise a material such as crystalline silicon (e.g., Si<100> or Si<111>), silicon oxide, strained silicon, silicon germanium, doped or undoped polysilicon, doped or undoped silicon wafers, patterned or non-patterned wafers, silicon on insulator (SOI), carbon doped silicon oxides, silicon nitride, doped silicon, germanium, gallium arsenide, glass, sapphire, or the like. In some embodiments, the substrate 106 may be, for example, a disk-shaped, eight inch (200 mm) or twelve inch (300 mm) diameter silicon substrate, although other sizes and geometries are contemplated.

The gas distribution apparatus 114 is disposed in a position relative to the substrate support 108 to provide one or more processes gases to a front side 107 (e.g., a processing side or circuit side) of the substrate 106. For example, in some embodiments, the gas distribution apparatus 114 may be disposed above the substrate support 108, such as shown in FIG. 1.

The gas distribution apparatus 114 may be fabricated from any material that is non-reactive to the process gases and/or process environment within the process chamber 100 during processing. For example, in some embodiments, the gas distribution apparatus 114 may be fabricated from a metal (e.g., stainless steel, aluminum, or the like) or a ceramic (e.g., silicon nitride (SiN), alumina (Al₂O₃), or the like). Alternatively, in some embodiments, for example where the lamp array 101 is disposed above the substrate support 108, the gas distribution apparatus 114 may be fabricated from a transparent material to allow radiative heat to reach the substrate 106 from the lamp array 101, for example such as crystalline quartz (SiO₂), vitreous silicon oxide (SiO₂), transparent alumina (Al₂O₃) (e.g., sapphire), translucent alumina (Al₂O₃), yttrium oxide (Y₂O₃), or coated transparent ceramics. Additional examples of materials suitable for a transparent showerhead are disclosed in U.S. Pat. No. 5,781,693, entitled “Gas Introduction Showerhead For An RTP Chamber With Upper And Lower Transparent Plates And Gas Flow Therebetween”, issued Jul. 14, 1998, to David S. Balance, et al., and assigned to the assignee of the present application.

The gas distribution apparatus 114 may generally comprises a plurality of plates (a first plate 167, second plate 169 and third plate 171 shown in FIG. 1) disposed above one another and spaced apart to form a gap between each of the plurality of plates 167, 169, 171. Each gap forms a plenum (a first plenum 163 and second plenum 165 shown) to allow a flow of gas therein. In some embodiments, the plurality of plates 167, 169, 171 may be coupled to one another via an outer wall 179. The plurality of plates 167, 169, 171 may comprise any shape suitable to fit within the chamber body 103 and allow for the delivery of process gases to a desired area of the inner volume 104. For example, the plurality of plates 167, 169, 171 may be circular, rectangular, or the like.

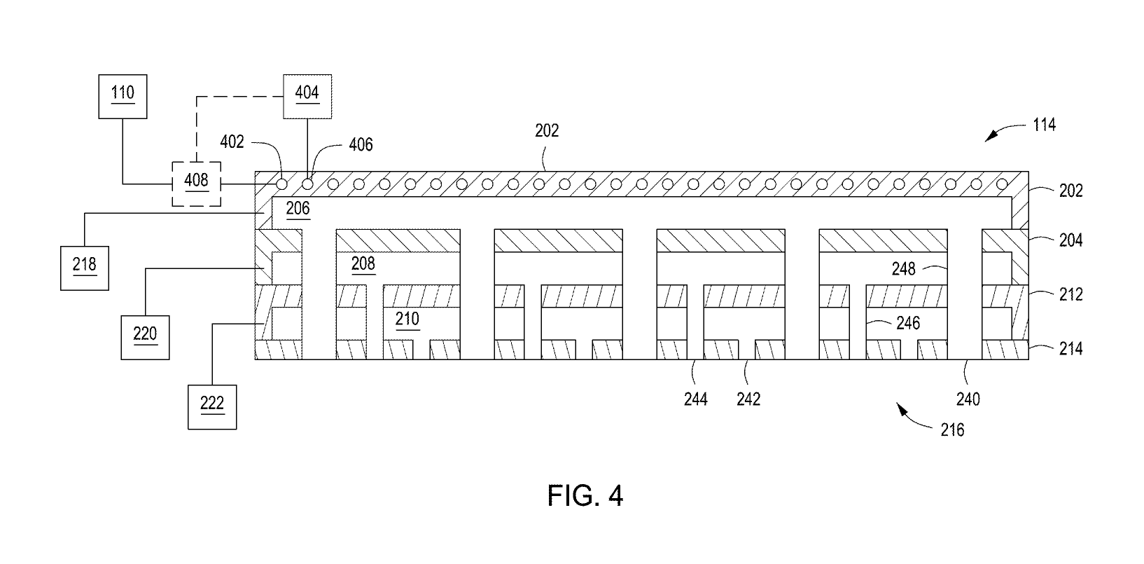

In some embodiments, the bottom most plate (i.e., the third plate 171) of the plurality of plates 167, 169, 171 comprises a plurality of ports that fluidly couple the inner volume 104 of the process chamber 100 to the plenums of the gas distribution apparatus 114. For example, FIG. 1 depicts a first set 160 of the plurality of ports coupled to the first plenum 163 and a second set 161 of the plurality of ports coupled to the second plenum 165. Additional sets of the plurality of ports may be coupled to additional plenums. In some embodiments, a plurality of conduits 175 may couple one or more of the plenums (e.g., the second plenum 165) to the ports (e.g., the first set 160 of ports). In a non-limiting example of operation, a gas supply 131 may provide one more process gases to the first plenum 163. The one more process gases flow through the first plenum 163 and through the first set 160 of ports to the inner volume of the process chamber 100. The process gases then react with one another and/or the top surface (e.g., front side 107) of the substrate 106 to perform a desired process. In some embodiments, a heat transfer fluid source 110 may be coupled to the gas distribution apparatus 114 to facilitate control of the temperature of the gas distribution apparatus 114, as discussed below with respect to FIG. 4.

When performing processes in a process chamber such as the process chamber 100 described above, as the process gases react with one another and/or the top surface of the substrate 106, reaction byproducts are formed. The reaction byproducts are evacuated from the inner volume 104 of the process chamber 100 via an exhaust port disposed on one or more sides of the process chamber 100 (e.g., the exhaust port 151 shown in FIG. 1), thus undesirably causing the reaction byproducts to flow across the front side 107 (e.g., top) of the substrate 106. Without wishing to be bound by theory, the inventor believes that the above described flow of reaction byproducts across the front side 107 of the substrate 106 may undesirably change the overall composition of gases at various points across the substrate 106, thereby impacting the reaction dynamics and affecting process gas reactions across the substrate 106, thus undesirably causing process non-uniformities. The inventor further believes that this effect may be exacerbated at an edge of the substrate 106 as the reaction byproducts accumulate as they flow across the substrate 106, providing a highest concentration of reaction byproducts proximate the edge of the substrate 106 closest to the exhaust port 151.

Accordingly, in some embodiments, a vacuum source 173 may be coupled to one or more of the plenums (e.g., the second plenum 165), such as a vacuum pump, to create a flow path away from the substrate 106 at one or more of the plurality of ports (e.g. second set 161 of ports). While not intending to be bound by theory, the inventor believes that by providing the vacuum in such a manner the reaction byproducts may be removed quickly and efficiently from the inner volume thereby reducing or eliminating the above described effect of the reaction byproducts on subsequent reactions near or on the substrate 106. The gas distribution apparatus 114 may be configured in any manner suitable to provide a necessary number of process gases to perform a desired process and to provide a desired pattern of process gas and reaction byproduct flow to facilitate the above described removal of reaction byproducts.

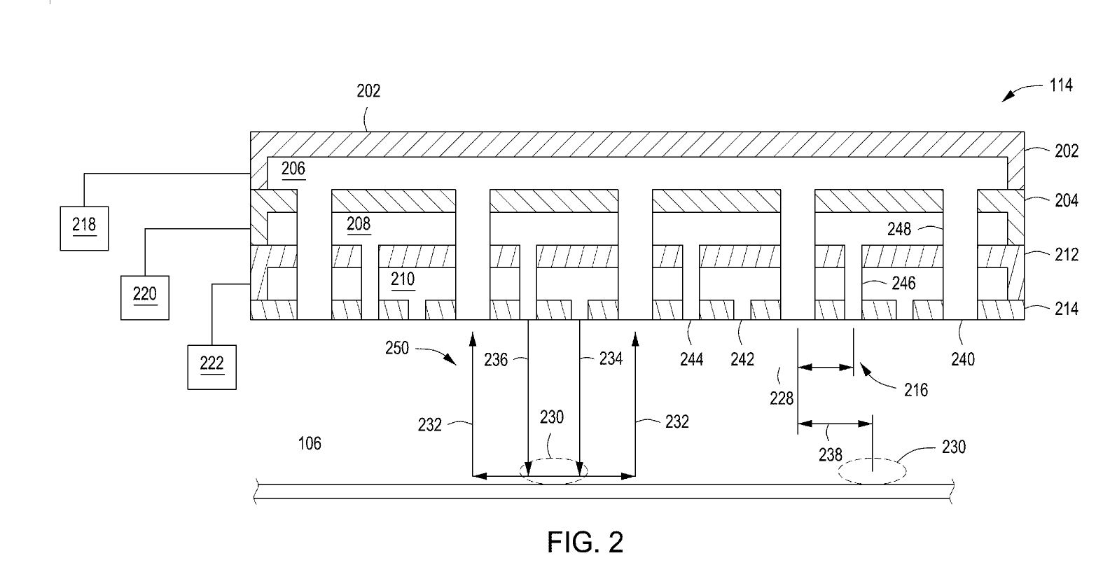

For example, referring to FIG. 2, in some embodiments, the gas distribution apparatus 114 may comprise a first plate 214, second plate 212, third plate 204, and fourth plate 202 disposed above one another in a spaced apart relationship. Each of the first plate 214, second plate 212, third plate 204, and fourth plate 202 is disposed in such a manner that a gap is disposed between each plate 214, 212, 204, 202 to respectively form a first plenum 210, a second plenum 208, and a third plenum 206. The respective positions of the plena and whether coupled to a gas source or to a vacuum source may be selected as desired for a particular application and is not limited to the configuration illustrated in FIG. 2. The first plate 214 comprises a plurality of ports 216 (a first set of ports 242, a second set of ports 244, and a third set of ports 240 shown) fluidly coupled to the first plenum 210, second plenum 208, and third plenum 206, respectively. A first set of conduits 246 and second set of conduits 248 fluidly couple the second set of ports 244 and third set of ports 240 to the second plenum 208 and third plenum 206, respectively, while isolating the second plenum 208 and third plenum 206 from each other and from the first plenum 210.

In some embodiments, process gases may be separately provided to an area proximate the substrate 106 via one or more of the plenums (e.g., the first plenum 210 and the second plenum 208) and respective ports (e.g., the first set of ports 242 and the second set of ports 244). For example, a first process gas supply 222 may be coupled to the first plenum 210 to provide a first process gas to an area proximate the substrate 106 via the first set of ports 242. A second process gas supply 220 may be coupled to the second plenum 208 to provide a second process gas to the area proximate the substrate 106 via the second set of ports 244. Providing the process gases separately prevents the process gases from mixing, and potentially reacting, prior to reaching a desired area near or on the substrate 106.

In some embodiments, a vacuum may be selectively applied to one or more of the plenums (e.g. the third plenum 206) to provide the desired pattern of process gas and reaction byproduct flow. For example, as shown in FIG. 2, a vacuum source 218 may be coupled to the third plenum 206 to provide a flow of gas in a direction away from the substrate 106 through the third set of ports 240 (e.g., to provide a flow of gas out of the process chamber.

In operation, the first process gas supply 222 and the second process gas supply 220 may provide a first and a second process gas, respectively, to an area (e.g., a reaction area 230) proximate or on the substrate 106 (flow of first and second process gas indicated by arrows 234, 236). The first and second process gases react in the reaction area 230, thereby forming a desired process composition in addition to reaction byproducts. The reaction byproducts are then removed from the reaction area 230 through the third set of ports 240 (flow of the reaction byproducts indicated by arrow 232).

The size, geometry, number, distribution and location of the ports 244, 242, 240 utilized for provision of process gases or removal of reaction byproduct may be selectively chosen to provide a desired pattern of process gas flow and reaction byproducts removal. For example, a cross section of the ports 216 in each set of ports 244, 242, 240 may be round, rectangular, square, oval, slotted, polygonal, combinations thereof, or the like. Each port 216 may have a cross-section configured, for example, control the flow rate and/or direction of a process gas flowing therefrom or thereto. In some embodiments, at least some ports 216 may have a cross section that varies along an axis parallel to the direction of gas flow. For example, in some embodiments, at least some ports 216 may have an expanding cross section to facilitate dispersing the process gas flowing therethrough.

In some embodiments, by altering the size or geometry of the ports 216 the velocity of the process gas provided to the substrate 106 may be adjusted. The inventor believes that adjusting the velocity of process gas flowing towards the substrate 106 may be necessary to allow the process gas to reach a desired area near or on the substrate 106 at the right temperature (e.g., the reaction area 230). For example, if the velocity of the process gas is not sufficient to overcome the counter flow to the exit port, the process gas may not reach the desired area. Alternatively, if the velocity of the process gas is excessive, the process gas my strike the substrate 106 and disperse or redirect outside of the desired area or be insufficiently thermally activated. Accordingly, in some embodiments, at least some ports 216 may have a tapering cross section to facilitate providing a higher velocity of the process gas flowing therethrough.

Other dimensions, for example the distance 228 between the ports utilized to remove the byproducts (e.g., third set of ports 240) and the ports utilized to provide the process gases (e.g., the first set of ports 242 and the second set of ports 244) or the distance 238 between the ports utilized to remove the byproducts and the reaction area 230 may be adjusted to provide a desired flow pattern of process gases and reaction byproducts.

The ports 216 (first set of ports 242, second set of ports 244 and third set of ports 240) may be distributed in any suitable configuration to achieve a desired flow of process gases and reaction byproducts. The distribution may be uniform or non-uniform, depending upon the process being performed in the process chamber. For example, in some embodiments, the ports 216 may be uniformly distributed across the entire surface of the first plate 214. Alternatively, in some embodiments, the ports 216 may be distributed along a portion of the first plate 214, such as in one or more lines, wedges, or the like. In such embodiments, one of the gas distribution apparatus 114 or the substrate 106 may be moved or rotated during processing to facilitate uniform distribution of the process gas to the substrate 106.

In another example, such as shown in the portion of the gas distribution apparatus 144 shown in FIG. 2, the ports may be disposed in a continuous repeating pattern comprising a first port 242, second port 244 and third port 240. However, the ports 242, 244, 240 may be arranged in any manner suitable to provide the desired flow of process gases and reaction byproducts. For example, the ports 242, 244, 240 may be grouped into one or more desired locations or zones, thus providing a localized area 250 or “cell” of process gas provision to the reaction area 230 (indicated by arrows 234, 236) and removal of the subsequent reaction byproducts away from the substrate 106 (indicated by arrows 232).

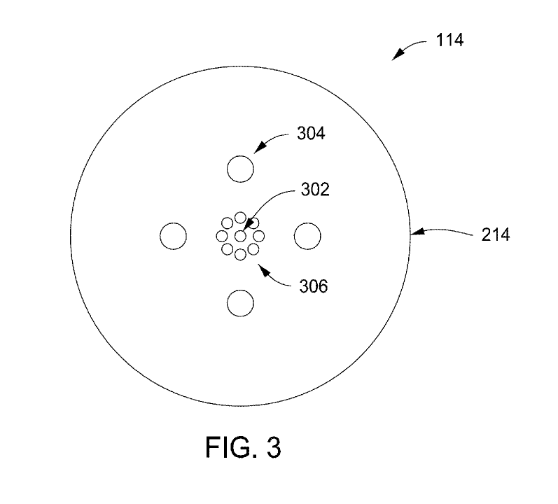

For example, referring to FIG. 3, in some embodiments, a first plurality of ports 306 configured to provide one or more process gases may be disposed proximate a center 302 of the first plate 214 and a second plurality of ports 304 to which a vacuum has been applied may be disposed about a periphery of the first plurality of ports 306. Other sets of ports (not shown in FIG. 3) may be disposed about the first plate 214 to provide a desired flow of process gases and reaction byproducts.

In some embodiments, as depicted in FIG. 4, the gas distribution apparatus 114 may be coupled to a heat transfer fluid source 110 to provide a heat transfer fluid to facilitate control of the temperature of the gas distribution apparatus 114 during use (i.e., to heat or to cool the gas distribution apparatus 114). The heat transfer fluid may be any process-compatible heat transfer fluid suitable for the temperature range and material requirements. Non-limiting examples include water, heat transfer oils, mineral oils, silicone oils, aqueous glycol solutions, gases such as air, nitrogen, argon. In the case of transparent showerheads, a fluid having low absorptivity for most of the radiation being transmitted should be selected.

The heat transfer fluid source 110 may be coupled to one or more channels 402 disposed in the gas distribution apparatus 114. In some embodiments, the channel 402 may be formed between plates of the gas distribution apparatus 114, as discussed above with respect to the plenums 206, 208, 210. Similarly as discussed with respect to the plenums 206, 208, 210, the position of the channel 402 is not limited to be above the plenums as shown in FIG. 4, but may also be disposed between plenums or beneath the plenums as well. The channel 402 includes an inlet to receive the heat transfer fluid and an outlet to return the heat transfer fluid to the heat transfer fluid source 110. In some instances, more than one channel 402 may be used. For example, a second heat transfer fluid source 404 may be coupled to a second one or more channels 406. The second heat transfer fluid source 404 provides a heat transfer fluid maintained at a temperature different than that of the first heat transfer fluid. Alternatively, the second heat transfer fluid source 404 may be coupled to the one or more channels 402 and the first heat transfer fluid source (heat transfer fluid source 110) and the second heat transfer fluid source 404 may selectively or proportionately provide respective heat transfer fluids at a desired temperature between the temperature of the first heat transfer fluid and the temperature of the second heat transfer fluid. Use of the first heat transfer fluid source 110 or of the first heat transfer fluid source 110 and the second heat transfer fluid source 404 advantageously facilitates maintaining the gas distribution apparatus 114 at a desired temperature suitable for the process gases being delivered, thereby, for example, facilitating providing one or more of desired process gas temperature and/or activation, or prevention of deposition in the vacuum line exhausting the materials through the gas distribution apparatus 114.

Returning to FIG. 1, the lamp array 101 may include any number of lamps suitable to provide a desired temperature profile across the substrate 106. In addition, the lamps may be divided into multiple zones to allow for controlled heating of different areas of the substrate 106. In some embodiments, the lamp array 101 may be disposed above the substrate 106 to direct radiative heat towards a front side 107 of the substrate 106. Alternatively, in some embodiments the lamp array may be configured to heat a back side 109 of the substrate 106 for example, such as by being disposed below the substrate 106 (shown in phantom at 159), or by directing the radiation to the back side of the substrate 106. In embodiments where the lamp array 101 is disposed above the substrate 106, such as shown in FIG. 1, a window 154 may be disposed between the lamp array 101 and the inner volume 104. The window 154 may comprise any transparent material suitable for use with a process chamber, for example such as quartz. When present, the window 154 functions to seal the inner volume 104 while allowing radiative heat to pass through window 154 into the inner volume 104. In some embodiments, for example where the gas distribution apparatus 114 is fabricated from a transparent material, the window 154 may be replaced by the gas distribution apparatus 114.

The substrate support 108 may be configured to be stationary, or in some embodiments, to rotate the substrate 106. The substrate support 108 generally comprises an edge ring (support ring) 134 to support the substrate 106 and a support cylinder 136 to support the edge ring 134. The edge ring 134 provides support to the substrate 106 proximate a peripheral edge of the substrate 106, thereby allowing a substantial portion of the substrate 106 to be exposed except for a small annular region about the outer perimeter. In some embodiments, to minimize thermal discontinuities that may occur near the edge of the substrate 106 during processing, the edge ring 134 may be fabricated from the same, or similar, material as that of the substrate 106, for example, silicon or silicon carbide. Although one configuration of the substrate support is shown in FIG. 1, other types of substrate supports or substrate support configurations may also be utilized. For example, in some embodiments, such as where the substrate support is configured to be utilized in an epitaxial chamber, the substrate support may include an edge supporting susceptor to support the substrate. In such embodiments, the substrate support may include a central support post having three or more support arms attached to the post and terminating in support pins which directly support the substrate and/or susceptor.

The support cylinder 136 may be fabricated from any materials suitable to support the edge ring 134 and substrate 106 within the processing environment. For example, in some embodiments, the support cylinder 136 may be fabricated from quartz (SiO₂). In such embodiments, the support cylinder 136 may be coated with silicon (Si) to render it opaque in the frequency range of a temperature monitoring mechanism, for example, such as a pyrometer (e.g., pyrometer 128 discussed below), thereby facilitating accurate measurements of the temperature monitoring mechanism. In addition, the silicon coating on the support cylinder 136 acts as a baffle to block out radiation from the external sources, thereby further allowing the temperature monitoring mechanism to take accurate measurements.

In embodiments where the substrate support is configured to rotate the substrate 106, the support cylinder 136 may be rotatably coupled to a rotational assembly 143. In some embodiments, the rotational assembly 143 may comprise an annular upper bearing 141, a plurality of ball bearings 137 and an annular lower bearing race (race 139). In such embodiments, a bottom portion 149 of the support cylinder 136 may be held by the annular upper bearing 141. The annular upper bearing 141 rests on the plurality of ball bearings 137 that are, in turn, held within the stationary, annular, lower bearing race 139. In some embodiments, the ball bearings 137 are made of steel and coated with silicon nitride to reduce particulate formation during operations. The annular upper bearing 141 is magnetically coupled to an actuator (not shown) which rotates the support cylinder 136, the edge ring 134 and the substrate 106 during processing. Alternatively, in some embodiments, the substrate support 108 may be magnetically levitated and rotated, magnetically rotated while being suspended on gas bearings, or rotated using a central support post.

In some embodiments, a purge ring 145 may be disposed within the inner volume 104 of the chamber body 103 and surrounding the support cylinder 136. When present, the purge ring 145 facilitates a flow of purge gas into the inner volume 104 from an area proximate the edge ring 134. In some embodiments, the purge ring 145 has an internal annular cavity 147 which opens up to a region above the annular upper bearing 141. The internal annular cavity 147 is connected to a gas supply 153 through a passageway 156. During processing, a purge gas is flowed into the chamber through the purge ring 145. Gases are exhausted through an exhaust port 151, which is coupled to a vacuum pump 155. In some embodiments, the edge ring 134 comprises an outwardly extending annular edge 112 extends beyond the support cylinder 136. The annular edge 112 in cooperation with the purge ring 145 located below it, functions as a baffle which prevents stray light from entering a reflecting cavity 118 disposed beneath the substrate 106.

In some embodiments, for example where the lamp array 101 is disposed above the substrate 106, a reflective plate 102 may be disposed beneath the substrate 106. When present, the backside 109 of the substrate 106 and a top 120 of the reflective plate 102 form a reflecting cavity 118. The reflecting cavity 118 enhances the effective emissivity of the substrate 106. In some embodiments, the reflective plate 102 may be mounted in a on a water-cooled base 116. When present, the base 116 includes a circulation circuit 146 through which coolant (e.g. a heater transfer fluid such as water, ethylene glycol, propylene glycol, or the like) circulate to cool the reflective plate 102. In some embodiments, the reflective plate 102 is fabricated from aluminum and has a highly reflective surface coating to enhance the reflectivity of the reflective plate 102.

In some embodiments, the temperatures at localized regions of the substrate 106 may be measured by a plurality of temperature probes 152a, 152b, 152c. In some embodiments, each temperature probe 152a, 152b, 152c may include a light pipe 126, such as, for example, a sapphire light pipe, that passes through a conduit 124 that extends from the backside of the base 116 through the top 120 of the reflective plate 102. The light pipe 126 is positioned within the conduit 124 so that its uppermost end is flush with or slightly below the upper surface of the reflective plate 102. The other end of light pipe 126 couples to a flexible optical fiber 125 that transmits sampled light from the reflecting cavity 118 to a pyrometer 128. In some embodiments, the pyrometer 128 is connected to a temperature controller 150 which controls the power supplied to the lamp array 101 in response to a temperature measured by the pyrometer 128. In embodiments where the substrate 106 is rotated during processing, each temperature probe 152a, 152b, 152c monitors a temperature profile corresponding to an annular ring area of the substrate 106.

Thus, embodiments of gas distribution apparatus for use in substrate processing systems have been provided herein. In some embodiments, the inventive gas distribution apparatus may advantageously provide for quick and efficient removal of process reaction byproducts from a surface of the substrate, thereby reducing or eliminating an effect the reaction byproducts may have on subsequent process reactions.

While the foregoing is directed to embodiments of the present invention, other and further embodiments of the invention may be devised without departing from the basic scope thereof.

1. A gas distribution apparatus, comprising:
a first plate having a plurality of ports disposed through the first plate, the plurality of ports including at least a first set of ports and a second set of ports;
a second plate disposed above and coupled to the first plate;
a third plate disposed above and coupled to the second plate;
a first plenum disposed between the first plate and the second plate and fluidly coupled to the first set of ports but not the second set of ports;
a second plenum disposed between second plate and the third plate and fluidly coupled to the second set of ports but not the first set of ports;
a gas supply coupled one of the first plenum or the second plenum; and
a vacuum source coupled to the other of the first plenum or the second plenum.

2. The gas distribution apparatus of claim 1, further comprising:
one or more conduits disposed through the second plate to fluidly coupled the second plenum to the second set of ports of the plurality of ports.

3. The gas distribution apparatus of claim 1, further comprising:
a fourth plate disposed above and coupled to the third plate; and
a third plenum disposed between the third plate and fourth plate, wherein the third plenum is fluidly coupled to a third set of ports of the plurality of ports.

4. The gas distribution apparatus of claim 3, further comprising:
one or more conduits disposed through the second plate and third plate to fluidly coupled the third plenum to the third set of ports of the plurality of ports.

5. The gas distribution apparatus of claim 1, wherein the gas distribution apparatus is fabricated from quartz (SiO₂) or vitreous silicon oxide (SiO₂).

6. The gas distribution apparatus of claim 5, the gas distribution apparatus is fabricated from transparent quartz.

7. The gas distribution apparatus of claim 1, wherein the first plate is coupled to the second plate and the second plate is coupled to the third plate via an outer wall circumscribing the first plate, second plate and third plate.

8. The gas distribution apparatus of claim 1, wherein the gas distribution apparatus is disposed opposite a support surface of a substrate support within a process chamber, the process chamber comprising a radiant heating source disposed above or below the substrate support.

9. The gas distribution apparatus of claim 8, wherein the substrate support is rotatably coupled to the process chamber.

10. The gas distribution apparatus of claim 1, further comprising:
a channel having an inlet and an outlet to flow a heat transfer fluid through the gas distribution apparatus during use.

11. A process chamber, comprising:
a processing volume with a substrate support disposed therein; and
a gas distribution apparatus disposed opposite the substrate support to provide one or more gases to a substrate when disposed on the substrate support, the gas distribution apparatus comprising;
a first plate having a plurality of ports disposed through the first plate;
a second plate disposed above and coupled to the first plate;
a third plate disposed above and coupled to the second plate;
a first plenum disposed between the first plate and the second plate and fluidly coupled to a first set of the plurality of ports;
a second plenum disposed between second plate and the third plate and fluidly coupled to a second set of the plurality of ports;
a gas supply coupled to one of the first plenum or the second plenum to provide a process gas to the processing volume; and
a vacuum source coupled to the other of the first plenum or the second plenum to remove reaction byproducts formed from a process gas reaction from the processing volume.

12. The process chamber of claim 11, further comprising:
one or more conduits disposed through the second plate to fluidly couple the second plenum to the second set of the plurality of ports.

13. The process chamber of claim 11, further comprising:
a fourth plate disposed above and coupled to the third plate;
a third plenum disposed between the third plate and fourth plate; and
a gas supply coupled to the third plenum to provide a process gas to the processing volume via a third set of ports of the plurality of ports.

14. The process chamber of claim 13, further comprising:
one or more conduits disposed through the second plate and third plate to fluidly coupled the third plenum to the third set of ports of the plurality of ports.

15. The process chamber of claim 11, wherein the gas distribution apparatus is fabricated from quartz (SiO₂) or vitreous silicon oxide (SiO₂).

16. The process chamber of claim 15, the gas distribution apparatus is fabricated from transparent quartz.

17. The process chamber of claim 11, wherein the first plate is coupled to the second plate and the second plate is coupled to the third plate via an outer wall circumscribing the first plate, second plate and third plate.

18. The process chamber of claim 11, further comprising:
a radiant heating source disposed above or below the substrate support.

19. The process chamber of claim 11, wherein the substrate support is rotatably coupled to the process chamber.

20. The process chamber of claim 11, wherein the gas distribution apparatus further comprises:
a channel having an inlet and an outlet to flow a heat transfer fluid through the gas distribution apparatus; and
a heat transfer fluid source coupled to the channel to provide the heat transfer fluid to the channel during use.
